(19) United States
(12) Patent Application Publication
(10) Pub. No.: US 2022/0176580 A1
(43) Pub. Date: Jun. 9, 2022

(54) WOODWORKING MACHINE HAVING A DISENGAGEABLE PARALLEL STOP

(71) Applicant: ALTENDORF GMBH, Minden (DE)

(72) Inventors: Markus Ottemeier, Lage (DE); Jürgen Ruchatz, Minden (DE); Ralf Kühlmann, Bielefeld (DE)

(73) Assignee: ALTENDORF GMBH, Minden (DE)

(21) Appl. No.: 17/598,576

(22) PCT Filed: Mar. 24, 2020
(86) PCT No.: PCT/EP2020/058167

§ 371 Date: Sep. 27, 2021

(30) Foreign Application Priority Data
Mar. 28, 2019 (DE) 20 2019 101 777.5

(51) Int. Cl. B27B 5/22; B27B 27/02

(52) U.S. Cl. CPC B27B 5/222; B27B 27/02

(57) ABSTRACT

A woodworking machine, such as a sliding table saw includes a workpiecee table with a substantially horizontal workpiece support surface and a sawing slot. A saw unit with a circular saw blade is arranged so as to be able to protrude from the sawing slot and defines a substantially horizontal saw line. A workpiece stop is movably arranged above the workpiece support surface with a vertically standing workpiece stop surface, such that a plate-shaped workpiece resting on the workpiece support surface in a support region arranged horizontally in front of the workpiece stop can be placed with a side edge against the workpiece stop surface. A, sensor device is configured to generate a sensor signal, wherein the sensor signal characterizes an end of cut.

### CROSS-REFERENCE TO FOREIGN PRIORITY APPLICATION

The present application claims the benefit under 35 U.S.C. §§ 119(b), 119(e), 120, and/or 365(c) of PCT/EP2020/0058167 filed Mar. 24, 2020, which claims priority to German Application No. 202019101777.5 filed Mar. 28, 2019.

### FIELD OF THE INVENTION

The invention relates to a woodworking machine, in particular a sliding table saw, and a method for controlling a woodworking machine.

### BACKGROUND OF THE INVENTION

Woodworking machines, in particular sliding table saws, are used to cut large-format panels, in particular panels made of wood-based material or solid wood, plastic panels, or panels made of light metals. Woodworking machines of the type according to the invention have a substantially horizontal workpiece support surface onto which the workpiece can be placed by a user or an automatic feeding device. On the substantially horizontal workpiece support surface, the workpiece can be displaced horizontally, for example, by means of an air cushion or supported by other support devices, in order to be positioned in a defined manner with respect to a saw unit and its direction of movement.

The saw unit is arranged below the workpiece support surface in woodworking machines of the type according to the invention. The saw unit comprises a circular saw blade. The circular saw blade and a saw slot arranged in the workpiece table are arranged such that the circular saw blade protrudes from the saw slot. Preferably, the circular saw blade protrudes from the saw slot with a circumferential portion, wherein an axis of rotation of the circular saw blade is arranged below the workpiece table. A relative movement between the workpiece and the rotationally moving circular saw blade effects a cut on the workpiece.

In order to cut a workpiece to a predetermined, exact dimension, it is known to provide an adjustable stop surface on such a sliding table saw. The workpiece can then be placed with one edge against this stop surface and, in this contact, be guided along the stop surface to the saw blade and through the saw blade. In this way, a predetermined distance between the stop surface and the circular saw blade is precisely maintained as the cutting dimension. In principle, the workpiece can be guided along the fixed stop surface during the cut, or the stop surface is guided movably in the cutting direction and moves with the cut so that the workpiece rests immovably against it during the cut. The workpiece section to be cut to size is often located between the saw blade and the stop surface, and the saw blade is, therefore, located between the remaining section to be cut and the stop surface. However, it is also possible to work in such a way that the workpiece is cut to size by cutting off a residual section that is predetermined to size, in which case the residual section lies between the stop surface and the saw blade and the saw blade lies between the workpiece section to be produced and the stop surface.

From EP 0 624 430 A1 a sliding table saw with a right-hand stop and a tiltable saw blade is known, whereby the right-hand stop is arranged parallel to a workpiece plane formed by a saw blade. The right-hand stop serves to guide a workpiece parallel during a cut with the saw blade.

Woodworking machines are subject to occupational safety requirements and are, therefore, equipped with safety devices. This is to prevent the operator from injuring himself on the tool, such as the rotating saw blade of the machine. For this purpose, the saw blade is enclosed in a protective hood and the workpiece may be guided by a push stick to prevent direct contact between the operator's hand and the tool. In addition, personal safety equipment is worn by operators working on the machine, such as protective gloves or goggles. Technologically elaborate safety devices have further been proposed for sliding table saws, which aim to detect a hazard to the operator's hand or arm and achieve accident prevention by stopping or lowering the saw blade when a hazard is detected. However, it has been shown that despite these safety measures and devices, there is still a hazard potential from such woodworking machines.

The invention is based on the problem of providing a woodworking machine which makes it possible to achieve a substantial reduction in a risk of injury during work on the woodworking machine while maintaining economical processing of a workpiece with the woodworking machine, and in order to avoid damage to the workpiece.

### SUMMARY OF THE INVENTION

According to the invention, this task is solved with a woodworking machine of the type described above, comprising a workpiece table with a substantially horizontal workpiece support surface and a saw slot, a saw unit with a circular saw blade arranged to protrude from the saw slot and defining a substantially horizontal saw line, a workpiece stop movably arranged above the workpiece support surface with a vertically standing workpiece stop surface which is arranged such that a plate-shaped workpiece resting on the workpiece support surface in a support area arranged horizontally between the saw blade and the workpiece stop can be placed with a side edge against the workpiece stop surface, the sensor device is configured to generate a sensor signal, wherein the sensor signal characterizes a start of cut or an end of cut, an actuator which is mechanically coupled to the workpiece stop or the saw unit, and a control unit which is coupled to the actuator and the sensor device in terms of signaling, wherein the control unit is configured to receive the sensor signal and to generate an actuator control signal in dependence of the sensor signal and transmit it to the actuator, and the actuator is adapted to move the workpiece stop or the saw unit upon receipt of the actuator control signal in such a way that a clamping distance leading to clamping of the workpiece between the circular saw blade and the workpiece stop surface is eliminated.

The invention is fundamentally based on the realization that an additional hazard potential for the operator emanates from the guided situation of the workpiece on a stop surface. Due to this guidance, a workpiece section is arranged between the tool and the stop surface. It is true that the space available for this workpiece section is just sufficient to guide the workpiece section therein in the machining direction. The workpiece section can also be guided directly by the operator, or it can be guided indirectly by the operator—as long as it is still connected to the workpiece section guided by the operator. But as soon as the workpiece section arranged between the tool and the stop surface is slightly tilted, tilted, or pressed against the tool for other reasons, according to the inventors' finding there is a risk that a force is exerted on the workpiece section by the movement of the tool in the direction of the operator side, which can lead to acceleration of the workpiece section. Furthermore, the free movement for the removal of the cut piece of wood may be restricted by the clamping, whereby this must be ensured for removal.

In the sense of the invention, this is understood as “clamping” and the distance present during this clamping, in which the workpiece section rests quasi directly against the tool and the stop surface, is understood as “clamping distance.” An active clamping in the sense of a gripping, a clamping feed movement as in the case of pliers, clamps, or the like is typically not to be understood here in the sense of the invention, since the stop surface and the tool do not move towards each other transversely to the cutting direction during the cutting process—as in the case of such a gripping movement.

The distance between the stop surface and the tool leading to clamping can be eliminated, in particular, by moving the stop surface or the tool away from each other in such a way that the distance between the stop surface and the tool is increased, in particular, by moving the tool and/or the stop surface in a direction perpendicular to the cutting direction. For example, the stop surface can be moved horizontally away from the tool, or the tool can be moved horizontally away from the stop surface. Likewise, the stop surface and/or the tool can be moved vertically, for example, lowered below the support surface of the workpiece.

According to the inventors' finding, the risk of jamming and of the workpiece section being hurled away and damaged is particularly increased as soon as the workpiece section is no longer guided or is separated from the rest of the workpiece. In this situation, there is a risk that the workpiece section will be tilted and thus jammed between the tool—such as a circular saw blade—and the workpiece stop surface, causing it to accelerate. The workpiece section can then be hurled against the operator, striking and injuring him. This hazard is avoided according to the invention.

The workpiece table is adapted to support a workpiece. For this purpose, a substantially horizontal workpiece support surface is formed by the workpiece table. The saw slot is also arranged in the workpiece table. The saw slot preferably has an elongated geometry. In particular, the saw slot is arranged and designed in such a way that at least a section of the circular saw blade can be guided through it. In particular, the saw slot is arranged and formed in such a way that a circumferential section of the circular saw blade can be guided through it, so that this circumferential section is positioned above the workpiece support surface. The saw slot preferably extends with its main extension direction parallel to the saw line.

The saw unit may comprise a bearing for the circular saw blade. Furthermore, the saw unit preferably comprises a drive for the circular saw blade. The drive for the circular saw blade preferably drives the circular saw blade in a rotational direction, so that the circular saw blade is configured to perform a cut on a workpiece. Preferably, a scoring saw blade is further arranged on the saw unit, which can protrude from the workpiece table in the direction of the horizontal saw line in front of the circular saw blade. Preferably, the saw unit and/or the circular saw blade is arranged such that this or these can be moved in a vertical direction. Preferably, the circular saw blade can be moved completely below the workpiece support surface, but can also be arranged with a circumferential portion above the workpiece support surface. Furthermore, the circular saw blade can be arranged in a non-movable manner in the vertical direction with respect to the workpiece support surface.

The saw line is formed by the horizontal and a diametrical extension of the circular saw blade. In particular, the saw line is to be understood as a straight line defining a cutting direction.

The workpiece stop is movably arranged above the workpiece support surface. The workpiece stop can, for example, be arranged on the workpiece support surface of the workpiece table. The movable arrangement of the workpiece stop can be realized, for example, with a linear guide, whereby the workpiece stop can be moved with this linear guide in a horizontal direction, which is preferably aligned orthogonally to the saw line. Furthermore, the movable arrangement of the workpiece stop can be realized by a pivoting mechanism, wherein the workpiece stop has a substantially vertical pivot axis. The pivot axis is preferably arranged in front of the saw slot in the cutting direction. Furthermore, the movable arrangement of the workpiece stop can be realized by means of a linear guide and a pivoting mechanism.

The workpiece stop comprises the vertically positioned workpiece stop surface. The workpiece stop surface preferably extends parallel to the circular saw blade. The workpiece stop surface is arranged in such a way that a plate-shaped workpiece resting on the workpiece support surface in a support area arranged horizontally in front of the workpiece stop can be placed with a side edge against the workpiece stop surface. The distance of the workpiece stop from the saw line is preferably adjustable.

The woodworking machine according to the invention further comprises the sensor device. The sensor device is arranged to generate a sensor signal characterizing a start of cut and/or end of cut. A start of cut is to be understood as the event at which the tool first contacts the workpiece to perform the cutting operation. An end of cut is to be understood, in particular, as the event when a workpiece has been completely cut through. In particular, the sensor device can be adapted to detect a start of cut and/or an end of cut. As will be explained in more detail below, the detection of a start of cut and/or an end of cut and the generation of the sensor signal characterizing the end of cut or the start of cut can be performed in different ways. For example, position of the workpiece can be detected capacitively or optically and the start of cut and the end of cut can be determined on the basis of the position detection. The sensor device is preferably arranged between the circular saw blade and the workpiece stop. The sensor device can also be formed by a logic circuit which only detects the cutting progress and calculates the end of cut from this as a function of a previously known cutting length and detects it in this way. Furthermore, the cutting process can be detected acoustically and the start or end of cut can be determined on the basis of the acoustic detection.

In principle, the sensor device can be designed for direct sensory detection of the start of cut and/or the end of cut, for example, by detecting the workpiece edge located at the start of cut or the end of cut. By detecting the end of cut, the condition that triggers a movement of the workpiece stop to prevent jamming can be detected directly, in that the workpiece stop actuator is activated immediately or in a predetermined time-delayed manner when the end of the workpiece is detected. By detecting the start of cut, the sensor device can also be designed for indirect detection of the end of cut, for example, by calculating the end of cut on the basis of previously known workpiece data such as a cut length and on the basis of the detected start of cut and a cutting feed rate. In the case of indirect determination of the end of cut, the end of cut can also be calculated in advance and, consequently, a control and movement of the actuator can be carried out shortly before the actual end of cut in order to cancel the clamping distance.

The actuator is mechanically coupled with the workpiece stop or the saw unit. The coupling of the actuator with the workpiece stop is configured in particular in such a way that the actuator moves the workpiece stop. Furthermore, it is preferred that the actuator can move the saw unit. The movement of the workpiece stop or the saw unit, which is effected by the actuator, can be linear and/or rotational.

The actuator is furthermore coupled to the sensor device in terms of signaling via the control unit. The control unit of the woodworking machine is preferably adapted to generate an actuator control signal upon generation of the sensor signal by the sensor device. For example, the actuator control signal can be generated by the control unit, which will be explained in more detail below. For example, the control unit can generate the actuator control signal upon receiving the sensor signal and send it to the actuator. In particular, the actuator is configured to receive the actuator control signal.

The actuator is arranged and adapted to move the workpiece stop or the saw unit upon receipt of the actuator control signal in such a way that a clamping distance leading to clamping of the workpiece between the circular saw blade and the workpiece stop surface is suspended. When sawing a plate-shaped workpiece that is in contact with a workpiece stop, a clamping between the circular saw blade and this workpiece stop usually results.

The invention is based on the realization that it is precisely this clamping between the workpiece stop and the circular saw blade that leads to hazardous situations. The workpiece located between the circular saw blade and the workpiece stop can be accelerated by the rotation of the circular saw blade. This acceleration can have such an effect that the workpiece is hurled away from the workpiece support surface. The workpiece being hurled away generally leads to a hazardous situation. In particular, an operator or another person who is in the hurling area of the workpiece is exposed to a risk of danger. The woodworking machine according to the invention reduces the potential hazard from workpieces hurling around by preventing the jamming of a workpiece between the saw blade and the workpiece stop surface by moving the workpiece stop or the saw unit and thus the circular saw blade. In addition, the risk of releasing saw teeth of the circular saw blade, which also pose a risk of hazard, is reduced.

In principle, the actuator can be controlled after the cut has been executed, in which case the end of cut corresponds to the end of the cutting process. In principle, however, the end of the workpiece can also be detected by the sensor unit as the end of cut and the actuator can be controlled before the cutting process is completed. For example, it is often sufficient if the workpiece is guided along the saw line by the saw blade alone in the last part of the cutting process, for example, in the last 10%, 5%, or less of the cutting length, and no longer by the workpiece stop. In embodiments in which the clamping distance is suspended by moving the workpiece stop by means of the actuator, a workpiece edge position in relation to the saw blade can, therefore, also be determined or calculated by the sensor device as the end of cut and the actuator can be controlled before the cutting process is completed in order to suspend the clamping distance.

In addition, the woodworking machine according to the invention improves work efficiency. The workpiece located between the workpiece stop and the circular saw blade is in a non-clamped release position after sawing. The operator does not have to release the clamping by a manual action before, for example, by disengaging the parallel stop.

The clamping distance preferably extends in a horizontal direction and transverse to the saw line between the circular saw blade and the workpiece stop surface. The suspending of the clamping distance means, in particular, that the clamping distance between the circular saw blade and the workpiece stop surface is increased. This increasing can take place on the one hand by a movement of the workpiece stop and on the other hand by a movement of the circular saw blade. After the clamping distance has been increased by the movement of the workpiece stop and the workpiece has been removed, the workpiece stop can be moved back again. The workpiece stop can be moved back manually or automatically. The automated moving back is preferably sensor-supported, so that the moving back only takes place when there is no workpiece on the workpiece support surface. If the clamping distance has been increased by lowering the circular saw blade, the circular saw blade can be moved back to a sawing position after removing the workpiece. Furthermore, the circular saw blade can be pivoted again to a desired sawing position after a clamping distance has been increased by pivoting the circular saw blade and the processed workpiece has been removed.

According to a preferred embodiment, it is provided that the workpiece stop is configured as a parallel stop, in particular, as a right-hand stop, wherein the workpiece stop surface of the parallel stop is aligned parallel to the circular saw blade, and wherein the actuator is configured as a parallel stop actuator and is configured to move and/or pivot the parallel stop back and forth to suspend the clamping distance, and/or the workpiece stop is configured as a stop flap on an angular stop, wherein the actuator is configured as a flap actuator and configured to move and/or to pivot the stop flap back and forth to suspend the clamping distance, and/or the saw unit is configured for pivoting the circular saw blade about a horizontal axis aligned transversely to the saw line in order to suspend the clamping distance, and the actuator is configured as a saw blade actuator and is configured to displace or pivot the saw blade in order to suspend the clamping distance.

The actuator designed as a parallel stop actuator is mechanically coupled to the parallel stop preferably in such a way that the actuator moves the parallel stop away from the circular saw blade when the actuator control signal is received. The parallel stop can also be pivoted about a horizontal axis, the horizontal axis preferably being arranged in front of the saw slot in the direction of sawing, so that the clamping distance is suspended when the parallel stop is pivoted.

A clamping of a workpiece between the circular saw blade and the workpiece stop configured as a stop flap can be carried out by actuating the actuator designed as a flap actuator. For this purpose, the stop flap is preferably moved away from the circular saw blade by the flap actuator linearly moving and/or pivoting the stop flap, for example.

In addition, the clamping distance between the circular saw blade and the workpiece stop can be suspended or increased by moving the circular saw blade away from the workpiece stop. This can be accomplished, for example, by pivoting the circular saw blade about the horizontal axis oriented transverse to the saw line, or by moving the circular saw blade along its axis of rotation. In particular, this can be accomplished by pivoting in such a manner that the circumferential portion of the circular saw blade arranged above the workpiece support surface is pivoted away from the workpiece stop.

The end edge of the plate-shaped workpiece can be detected by the sensor device, for example, by optical detection or acoustic detection. As will be explained in the following, the sensor device can detect the end edge of the plate-shaped workpiece by means of a workpiece sensor, for example. The workpiece sensor can, for example, be designed as a light barrier, a capacitive sensor, or an inductive sensor.

In a preferred embodiment, it is provided that the sensor device comprises at least one detection unit. The detection unit is preferably adapted to detect a start of cut and/or an end of cut. For example, the detection unit can detect the start of cut and/or the end of cut by means of a capacitive sensor, by means of optical detection, or by means of acoustic detection. Optical detection can be performed, for example, by means of an image-generating camera and an image evaluation unit. Acoustic detection can be performed, for example, on the basis of noise analysis, in that noises detected by a microphone are analyzed by a noise evaluation unit. For example, a noise in the environment of the circular saw blade can be analyzed. A noise in the vicinity of the circular saw blade during a cut usually has a higher sound pressure level than a noise in the vicinity of the circular saw blade while no cut is being made.

Furthermore, the detection unit can also detect a start of cut and/or an end of cut via a torque measurement at the drive of the circular saw blade, since the torque is higher during the cut than after the cut. Furthermore, this can be done via a power recording at the drive of the circular saw blade. Furthermore, a start of cut can be done by means of a detection of a start edge and/or an end of cut can be done by means of a detection of an end edge, as it will be explained in the following.

In a further preferred embodiment, it is provided that the sensor device is arranged to detect a start edge and/or an end edge of a plate-shaped workpiece at at least one predetermined position on the workpiece support surface and to generate the sensor signal, when the start edge and/or the end edge is detected at the predetermined position, wherein preferably the predetermined position is determined by means of a saw blade diameter of the circular saw blade, a saw blade height of the circular saw blade above the workpiece support surface, a workpiece thickness, and/or a saw blade pivot angle. In addition, a surface condition, a number of teeth, a tooth shape, a saw blade width, a saw shaft speed, a workpiece feed rate, a workpiece feed speed, and/or a dwell time of the workpiece on the sensor device can be taken into account.

Based on the position of the start edge and/or the end edge, a start of cut and/or an end of cut can be determined by knowing the position of the circular saw blade. The predetermined position can, therefore, be determined, in particular, by means of a saw blade diameter of the circular saw blade, the saw blade height of the circular saw blade above the workpiece support surface, and a workpiece thickness. For a circular saw blade with the same diameter that is always positioned the same way, the predetermined position is essentially determined by the workpiece thickness and the saw blade pivot angle.

It is preferred that the predetermined position is determined by the woodworking machine itself, for example, by a control unit, explained in more detail below. Furthermore, it is preferred that the saw blade diameter of the circular saw blade, the saw blade height of the circular saw blade above the workpiece support surface, and the saw blade pivot angle are determined by the woodworking machine itself by means of sensors. For example, the workpiece thickness can be entered at a user interface by an operator. In addition, the woodworking machine may include a workpiece thickness sensor arranged and adapted to determine the workpiece thickness of a workpiece positioned on the workpiece support surface.

According to another preferred embodiment, it is provided that the workpiece table comprises the sensor device and the sensor device comprises a first workpiece sensor and a second workpiece sensor, wherein preferably the first workpiece sensor and the second workpiece sensor are spaced apart in the direction of the saw line.

By means of two workpiece sensors spaced from each other in the direction of the saw line, a start edge and/or an end edge of a plate-shaped workpiece can be determined at at least two different positions along the saw line. It is preferred that the sensor device comprises a plurality of workpiece sensors spaced apart from each other in the direction of the saw line. For example, the plurality of workpiece sensors may be arranged in staggered matrix or array form, i.e., extending in two or more rows in the direction of the saw line, wherein the sensors in adjacent rows may be staggered with respect to each other, and in this way a particularly close arrangement of the individual sensors is achieved for finer longitudinal resolution in the direction of sawing as well as redundancy. In particular, it is preferred that the sensor device comprises a total of twenty-four workpiece sensors arranged sequentially in the direction of the saw line.

Another preferred embodiment provides that the sensor device comprises a third workpiece sensor, wherein the third workpiece sensor is arranged offset in a horizontal direction and transversely to the saw line with respect to the first workpiece sensor and second workpiece sensor, wherein preferably the third workpiece sensor is arranged between the first workpiece sensor and the second workpiece sensor in the direction of the saw line.

By a third workpiece sensor arranged in the direction of the saw line between the first workpiece sensor and the second workpiece sensor, the resolution for detecting the end edge of the plate-shaped workpiece is improved. According to a further preferred embodiment, it is provided that at least two of the workpiece sensors of the sensor device are arranged on a sensor carrier, wherein preferably the workpiece table comprises the sensor carrier and wherein further preferably the sensor carrier is recessed into the workpiece table.

Such a sensor carrier enables the replacement of the sensors in a simple and cost-effective manner. Preferably, the sensor carrier comprises all workpiece sensors of the sensor device. Furthermore, it is preferred that the sensor device is arranged on the sensor carrier. The sensor carrier is preferably recessed into the workpiece table so that it forms a plane with the workpiece support surface.

In a further preferred embodiment, it is provided that at least one workpiece sensor of the sensor device is arranged in the direction of the saw line in front of the saw slot.

In particular, the control unit is adapted to control the actuator, especially the parallel stop actuator, the flap actuator, or the saw unit. In particular, the actuator control signal generated by the control unit can control the actuator, in particular, the specific actuators described in the preceding. The actuator control signal is generated in dependence of the sensor signal. Since the sensor signal characterizes an end of cut, the actuator control signal is to move the workpiece stop in such a way that a clamping of the workpiece between the circular saw blade and the workpiece stop is suspended. The coupling of the control device with the actuator in terms of signaling is preferably configured wire-bound or wireless.

According to another preferred embodiment, the control unit may be configured to receive a guide signal, the guide signal characterizing a guiding cutting at the parallel stop or at the angle stop, wherein the control unit is further adapted to generate an actuator control signal upon receipt of a guide signal characterizing a guiding cutting at the angle stop, wherein the actuator moves the parallel stop away from the saw line upon receipt of the actuator control signal.

The guiding cutting at the parallel stop or at the angle stop can be determined, for example, via a fourth workpiece sensor. For example, the fourth workpiece sensor can be used to determine whether the workpiece is in contact with the parallel stop or the angle stop. After determining a positioning of the workpiece at the parallel stop or at the angle stop, the guide signal is generated. Preferably, the guide signal is generated by the fourth workpiece sensor.

According to another preferred embodiment, the workpiece table comprises a stop actuation sensor, wherein the stop actuation sensor is arranged in the direction of the saw line behind the saw slot and adapted to generate a first stop actuation signal, wherein the first stop actuation signal characterizes a non-presence of a workpiece in the area adjacent to the stop actuation sensor, wherein the control unit, upon receipt of the first stop actuation signal, generates a second actuator control signal which controls the actuator such that the workpiece stop is moved to move the workpiece stop surface toward the saw line, and the stop actuation sensor is adapted to generate a second stop actuation signal, wherein the second stop actuation signal characterizes a presence of a workpiece in the area adjacent to the stop actuation sensor, wherein the control unit, upon receiving the second stop actuation signal, generates a third actuator control signal that prevents a movement of the workpiece stop surface toward the saw line.

The stop actuation sensor can be formed as a single sensor. In this case, a single sensor element is provided which, for example, capacitively detects the presence of the workpiece at a specific point.

The stop actuation sensor detects a workpiece on the workpiece table. If a workpiece is positioned on the workpiece table, moving the workpiece stop involves the risk of jamming between the workpiece stop and the circular saw blade. This can damage the circular saw blade, the saw unit, the workpiece stop, or also the workpiece. It is, therefore, preferable to avoid moving the workpiece stop when a workpiece is present on the workpiece table.

According to a further preferred embodiment, it is provided that the control unit is adapted to generate a lowering signal when the sensor signal is received, wherein the lowering signal controls an actuator configured as a lowering actuator in such a way that the circular saw blade is moved below the workpiece support surface.

When the circular saw blade is lowered below the workpiece support surface, it is easier to move the workpiece on the workpiece table. In addition, the risk of damage to the workpiece on the circular saw blade is reduced or eliminated. Veneered wood workpieces, in particular, are sensitive on the surface, so that even a slight collision with the circular saw blade can lead to damage.

According to a further preferred embodiment, it is provided that the control unit is adapted to generate a saw blade switch-off signal when the sensor signal is received, wherein the saw blade switch-off signal controls a drive motor of the saw blade in such a way that the drive of the circular saw blade is switched off. Preferably, the circular saw blade is also actively braked.

Furthermore, it is preferred that at least one workpiece sensor and/or the stop actuation sensor is selected from the group consisting of optical sensors, capacitive sensors, inductive sensors, pneumatic sensors, linear longitudinal sensors, and ultrasonic sensors.

The sensor device or the stop actuation sensor can basically be adapted to detect the presence or absence of a workpiece at a specific location or point on the workpiece support surface and in this way detect a front or rear cutting edge by continuous measurement, whereby the start or end of cut can be detected if the sensor device is positioned accordingly. The sensor device or the stop actuation sensor can further be designed to detect more precise properties of the workpiece in addition to this binary signal, for example, its material thickness or the type of material. Optical sensors, capacitive sensors, inductive sensors, and ultrasonic sensors are particularly well suited for this purpose.

The optical sensors can be designed as light barriers, for example. If a workpiece is present above one of the workpiece sensors or above the stop actuation sensor, the presence of a workpiece is detected. With continuous monitoring of the light barrier, it can also be detected when there is no longer a workpiece above the workpiece sensor or the stop actuation sensor. This transition from detecting the presence of a workpiece and the absence of a workpiece can, for example, characterize an end of cut. Based on this, the sensor signal can then be generated by the sensor device.

Capacitive and inductive sensors can also be used to detect the presence or absence of a workpiece above the workpiece sensors. Furthermore, it is also possible to detect the presence and absence of workpieces with pneumatic sensors.

According to a further preferred embodiment, it is provided that the woodworking machine comprises a first workpiece stop and a second workpiece stop, wherein the first workpiece stop is configured as a parallel stop, in particular, as a right-hand stop, and the second workpiece stop is configured as a stop flap on an angle stop.

Furthermore, it is preferred that the woodworking machine comprises an indicating device that is adapted to signal, preferably indicate, a deviation from a predefined dimensional position of the workpiece stop to a user. The signaling may be provided, for example, by a flashing warning light, the warning light preferably being arranged in the table bar. Furthermore, a warning can appear on the display or an acoustic warning signal can be emitted. Two or more of the warning signals mentioned in the preceding may also be output.

A further aspect of the invention is a method for controlling a woodworking machine, in particular, a sliding table saw, comprising cutting a plate-shaped workpiece with a circular saw blade that defines a saw line, wherein one side of the workpiece is arranged at a workpiece stop surface of a movable workpiece stop, by means of a cut having a start of cut and an end of cut, detecting the start of cut and/or the end of cut, and moving the workpiece stop in such a way that, depending on the detection of the end of cut, a clamping distance leading to the clamping of the workpiece between the circular saw blade and the workpiece stop surface is suspended, by moving the workpiece stop surface or the saw blade by means of an actuator, in particular by moving the workpiece stop surface horizontally, pivoting the saw blade about a horizontal axis, or moving the saw blade vertically.

A preferred further embodiment of the method provides that after the end of cut has been determined, a drive of the circular saw blade and/or a chip extraction system is/are deactivated. Furthermore, it is preferred that after the end of cut has been determined, the drive of the circular saw blade is deactivated after a predetermined period of time, preferably between 10 seconds and 30 seconds, particularly preferably between 10 seconds and 20 seconds, if no further workpiece is detected on a workpiece support surface.

The method and its possible further developments comprise features or method steps which make them particularly suitable for being used for a woodworking machine according to the invention and its further developments. For further advantages, embodiment variants and embodiment details of these further aspects and their possible further developments, reference is also made to the previously given description concerning the corresponding features and further developments of the woodworking machine.

### BRIEF DESCRIPTION OF THE DRAWINGS

Preferred embodiments are explained by way of example with reference to the accompanying figures. It is shown by:

FIG. 1 is a perspective view of a woodworking machine;

FIGS. 2a and 2b are schematic, perspective views of the woodworking machine of FIG. 1;

FIG. 3 is a detailed perspective view of an embodiment of the woodworking machine shown in FIG. 1;

FIG. 4 is a detailed perspective view of a further embodiment of the woodworking machine shown in FIG. 1; and

FIG. 5 is a schematic method of controlling a woodworking machine.

### DETAILED DESCRIPTION FO THE EMBODIMENTS

In the figures, identical or essentially functionally identical or similar elements are designated with the same reference signs.

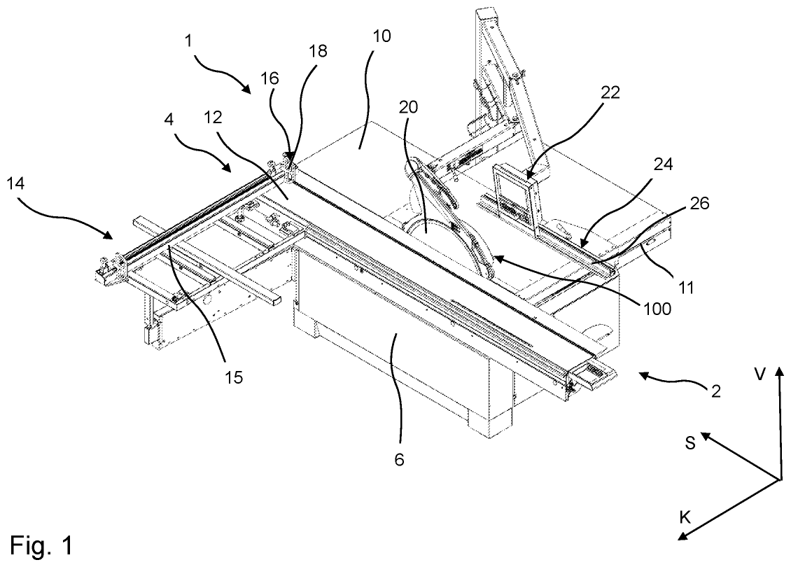

FIG. 1 shows a perspective view of a woodworking machine. The woodworking machine 1 extends from a front end 2 to a rear end 4. The woodworking machine 1 has a frame 6. A workpiece table 10 is arranged at the frame 6, wherein the workpiece table 10 is adapted to support a workpiece, in particular a plate-shaped workpiece.

A trimming carriage 12 is also arranged at the frame 6 in a linearly movable manner. The trimming carriage 12 is arranged to be movable in particular in a saw line direction S. A cross table 14 is also arranged at the edging carriage 12, projecting in the clamping direction K. The cross table 14 comprises a stop flap 16, wherein the stop flap 16 is formed as a workpiece stop surface on the side facing the circular saw blade 28, which will be explained in more detail below.

The cross table 14 can also be arranged to pivot about the vertical direction V and is preferably configured as a parallelogram cross table.

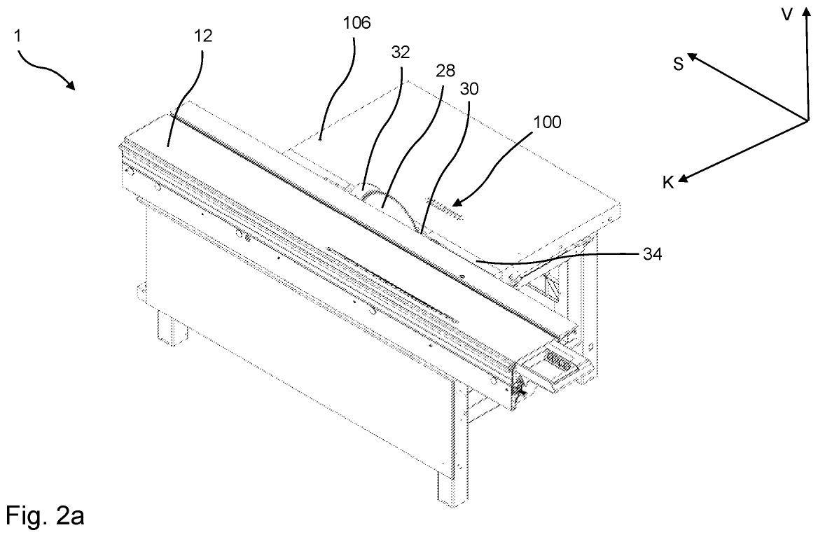

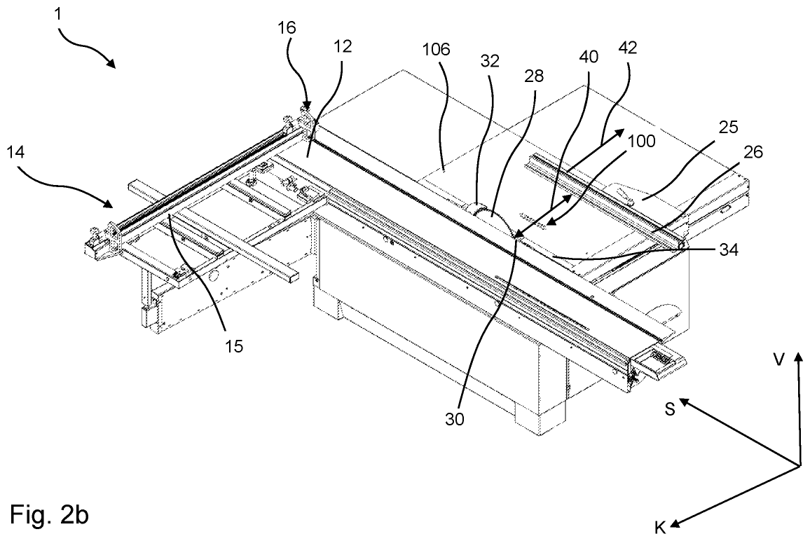

In the direction of the saw line S to the right of the trimming carriage 12, the circular saw blade 28 is arranged, as can be seen in particular from FIGS. 2a, 2b, 3, and 4. The circular saw blade 28 is a rotationally symmetrical disc with saw teeth arranged at the circumference generally at regular intervals. The circular saw blade 28 projects from a saw slot 30 with a circumferential portion.

The circular saw blade 28 may be arranged on a saw unit not shown here. The saw unit is generally arranged below the workpiece support surface of the workpiece table 10. The saw unit comprises, for example, drive elements that rotationally drive the circular saw blade 28. Furthermore, the saw unit can pivot the circular saw blade 28 about an axis aligned parallel to the direction of the saw line S. Furthermore, the saw unit can also move the circular saw blade 28 back and forth in the vertical direction V, for example, in order to set the circular saw blade 28 to a defined height above the workpiece table 10 and also in order to move the circular saw blade 28 below the workpiece support surface of the workpiece table 10. A splitting wedge 32 is arranged behind the circular saw blade 28 in saw line direction S. A scoring saw blade 38 is arranged in front of the circular saw blade 28 in saw line direction S.

The woodworking machine 1 further comprises a control unit 22 arranged on a cantilevered arm of a table column. Furthermore, the woodworking machine 1 comprises a protective hood 20 that is also arranged on a cantilevered arm of the table column. The protective hood position can be monitored during a sawing process.

A plate-shaped workpiece can be cut with the woodworking machine 1. For this purpose, the trimming carriage 12 is moved in the direction of the saw line S towards the front end 2. In this position, a workpiece is arranged on the trimming carriage 12, the workpiece table 10, and, if the workpiece is of a corresponding size, also on the cross table 14 in such a way that a first section of the workpiece is located to the right of the saw line 36 formed by the circular saw blade 28 in the saw line direction S and a second section of the workpiece is located to the left of the saw line 36. Cutting of the workpiece is effected by movement of the trimming carriage 12 and the workpiece disposed thereon in the direction of the saw line S from the front end 2 toward the rear end 4. Through this, a relative movement between the workpiece and the circular saw blade 28 is effected.

In order to be able to saw dimensionally accurate workpieces, workpieces are usually placed against workpiece stops. For this purpose, the woodworking machine 1 shown has a stop rail 15, the workpiece stop surface 18 of the stop flap 16, and a parallel stop 24. The parallel stop 24 is guided by a guide element 25. The parallel stop 24 has a second workpiece stop surface 26. When the workpiece is cut through, two workpiece parts are produced that are no longer connected to each other. One workpiece part is arranged to the left of the saw line 36 and one workpiece part is arranged to the right of the saw line 36. To detect against which workpiece stop a workpiece is placed, the workpiece stops may include sensors. For example, a sensor can be arranged on the parallel stop 24 and/or on the stop flap 16.

In particular, it is clear from FIG. 2b that a workpiece portion may be disposed between the circular saw blade 28 and the second workpiece stop surface 26 of the parallel stop 24. It frequently happens that the workpiece part is clamped between the circular saw blade 28 and the second workpiece stop surface 26. In the clamping direction K, a woodworking machine 1, therefore, has a clamping distance 40 between the circular saw blade 28 and the parallel stop 26 when the parallel stop 26 is set. In particular, the clamping distance is aligned parallel to an orthogonal direction of the circular saw blade 28 and/or the second workpiece stop surface 26.

A workpiece clamped between the parallel stop 24 and the circular saw blade 28 may perform uncontrolled movements due to the rotation of the circular saw blade 28, since usually this separated part of the workpiece is not guided by an operator. For example, the part of the workpiece clamped between the circular saw blade 28 and the parallel stop 24 may be hurled in the direction of the front end 2. In addition, the latter may also perform movements in the vertical direction V and thus damage parts of the woodworking machine 1. In particular, however, there is a safety risk for operators of the woodworking machine 1 and for other persons in the vicinity of the woodworking machine 1.

Accordingly, the invention proposes to cancel the clamping situation at the moment of workpiece separation. This is achieved by suspending the clamping distance 40. In a first variant, this can be done by disengaging the parallel stop 24 in the disengaging direction 42. For this purpose, the parallel stop 24 has a guide element 25 that is guided in a guide of the stop 11 of the woodworking machine 1.

Furthermore, the clamping distance 40 can be suspended by pivoting the circular saw blade 28 about an axis aligned parallel to the saw line direction S, in a counterclockwise direction as seen from the front end 2. In addition, clamping of a workpiece on the left side can be effected by moving the stop flap 16 to the left. The parallel stop 24 is preferably coupled to a parallel stop actuator. The parallel stop actuator is arranged to move the parallel stop 24 in the clamping direction K. In particular, the parallel stop actuator is configured to move the parallel stop 24 in the disengaging direction 42. In addition, the stop flap 16 can also be connected to an actuator.

In order to determine the time at which a workpiece is cut through and thus also to determine the time for suspending the clamping distance 40, the woodworking machine 1 comprises a sensor device 100. The sensor device 100 is adapted to detect the start of cut and/or the end of cut. As soon as the sensor device 100 detects the start of cut and/or the end of cut, the sensor device 100 generates a sensor signal. The actuators mentioned in the foregoing, in particular, the parallel stop actuator, are coupled to the sensor device 100 in terms of signaling and are configured in such a way that, when the sensor signal is generated, a disengagement of the parallel stop 24 in the disengaging direction 42, a movement of the stop flap 16 and/or a pivoting of the circular saw blade 28 takes place.

The actuators known in the foregoing are preferably configured, after the parallel stop 24 has been disengaged in the disengaging direction 42 or after the stop flap 16 has been moved or after the circular saw blade has been pivoted or moved, to move or pivot these back to the starting position.

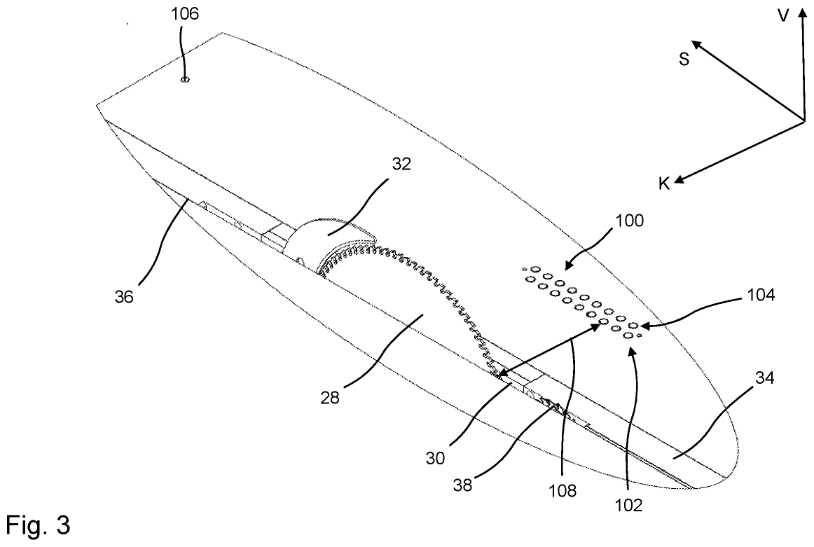

For example, the sensor device 100 detects the end of cut by detecting a rear edge of a workpiece. A rear edge of a workpiece is possible by means of the first row of workpiece sensors 102 and the second row of workpiece sensors 104 shown in FIG. 3. The workpiece sensors of the first row 102 and the second row 104 are arranged offset from each other in the direction of the saw line S. Furthermore, the first row 102 and the second row 104 are slightly spaced apart from each other in the clamping direction K. The sensor device 100 is spaced from the circular saw blade 28 by a sensor distance 108. In particular, it can be seen from FIG. 3 that an end of cut at a rear edge of a workpiece depends, in particular, on how far the circular saw blade 28 protrudes from the saw slot 30 in the vertical direction V. Furthermore, the position of the rear edge depends on the diameter of the circular saw blade 28. Other parameters to be taken into account for determining the end of cut can be a pivot angle of the circular saw blade 28 and a workpiece thickness.

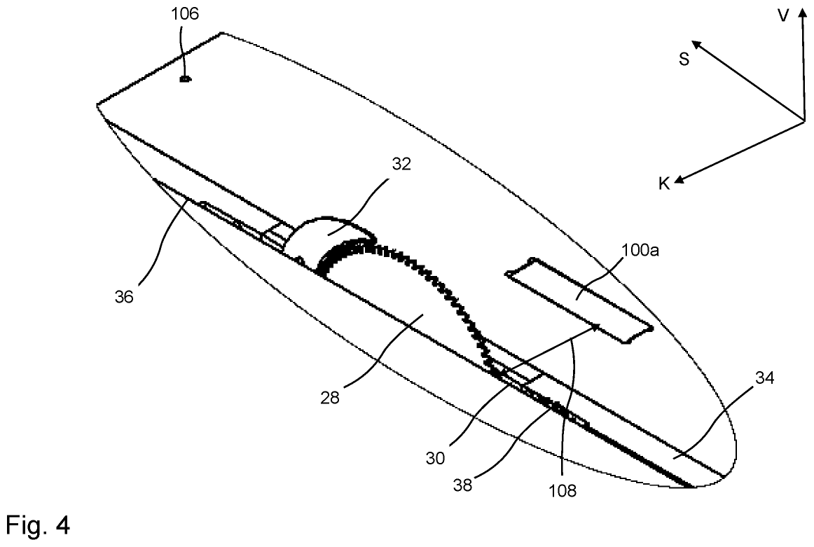

The workpiece sensors of the sensor device 100 are designed, in particular, in such a way that they can detect the presence and/or absence of a workpiece. Optical, capacitive, and inductive sensors are particularly suitable for this purpose. In addition, pneumatic sensors as well as ultrasonic sensors and linear link sensors are also conceivable. In addition, an end of cut can also be detected by means of a camera. The sensor device can also be designed as a sensor array 100a, as shown in FIG. 4. A sensor array 100a comprises a plurality of sensors as one component. The sensor array 100a may be recessed into the workpiece table 10, and preferably the upper surface of the sensor array 100a may be aligned with the upper support surface of the workpiece table 10. Advantageously, it is configured as an interchangeable component.

The workpiece table 10 further comprises a stop actuation sensor 106. The stop actuation sensor 106 is arranged behind the circular saw blade 28 in the saw line direction S. The stop actuation sensor 106 is preferably arranged in the saw line direction S in alignment with the sensor device 100 and/or the first row 102 of workpiece sensors and/or the second row 104 of workpiece sensors. The stop actuation sensor 106 is adapted to detect a workpiece located in the region adjacent to the stop actuation sensor 106. As a result, the stop actuation sensor 106 can detect a presence and a non-presence of a workpiece adjacent to the stop actuation sensor 106. It is preferred that movement of the parallel stop 24 in a direction opposite to the disengaging direction 42 is inhibited when a workpiece is present on the workpiece table 10, and, in particular, in an area adjacent to the stop actuation sensor 106, as this presents a risk of collision of the workpiece with the circular saw blade 28.

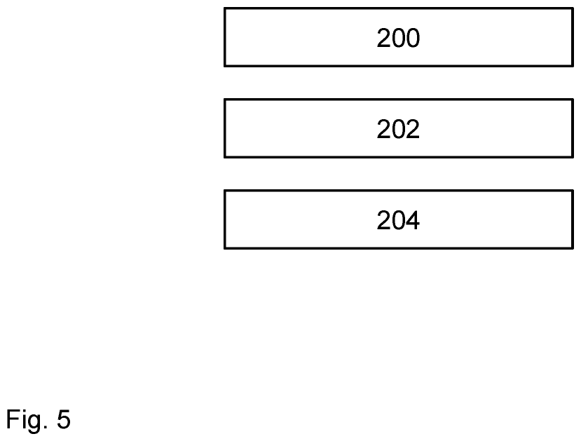

The method shown in FIG. 5 comprises the step of cutting 200 a plate-shaped workpiece with a circular saw blade 28 defining a saw line 36, wherein one side of the workpiece is arranged at a workpiece stop surface 18, 26 of a movable workpiece stop, for example, a parallel stop 26 or a stop flap 18. Further, the method comprises the step of determining 202 an end of cut.

Further, the method comprises the step of moving 204 the workpiece stop 16, 24 such that in response to detecting an end of cut, the workpiece stop surface is moved away from the saw line 36.

1-14. (canceled)

15. A woodworking machine comprising:
a workpiece table with a horizontal workpiece support surface and a saw slot;
a saw unit with a circular saw blade arranged to protrude from the saw slot and defining a horizontal saw line;
a workpiece stop movably arranged above the workpiece support surface, the workpiece stop having a vertically standing workpiece stop surface disposed such that a plate-shaped workpiece resting on the workpiece support surface in a support area arranged horizontally between the saw blade and the workpiece stop can be placed with a side edge against the workpiece stop surface; and
a sensor device;
wherein the sensor device is configured to generate a sensor signal, wherein the sensor signal characterizes a start of cut or an end of cut;
wherein an actuator is mechanically coupled to the workpiece stop or the saw unit;
wherein a control unit is coupled to the actuator and the sensor device in terms of signaling, and wherein the control unit is configured to receive the sensor signal and to generate an actuator control signal in dependence on the sensor signal and transmit it to the actuator; and
wherein the actuator is adapted to move the workpiece stop or the saw unit upon receipt of the actuator control signal such that a clamping distance leading to clamping of the workpiece between the circular saw blade and the workpiece stop surface is eliminated.

16. The woodworking machine according to claim 15, wherein:
the workpiece stop is configured as a parallel stop, wherein the workpiece stop surface of the parallel stop is aligned parallel to the circular saw blade, and wherein the actuator is configured as a parallel stop actuator and is configured to move or to pivot the parallel stop back and forth to suspend the clamping distance;
the workpiece stop is configured as a stop flap on an angular stop, and wherein the actuator is configured as a flap actuator and configured to move or to pivot the stop flap back and forth to suspend the clamping distance; or the saw unit is configured for pivoting the circular saw blade about a horizontal axis aligned transversely to the saw line to suspend the clamping distance, and wherein the actuator is configured as a saw blade actuator and is configured to displace or pivot the saw blade to suspend the clamping distance.

17. The woodworking machine according to claim 16, wherein the parallel stop is configured as a right-hand stop.

18. The woodworking machine according to claim 15, wherein the sensor device is disposed to detect a start edge or an end edge of a plate-shaped workpiece at at least one predetermined position on the workpiece support surface and generates the sensor signal when the start edge or the end edge is detected at the at least one predetermined position, wherein the predetermined position is determined by one or more of: a saw blade diameter of the circular saw blade; a saw blade height of the circular saw blade above the workpiece support surface; a workpiece thickness; or a saw blade pivot angle.

19. The woodworking machine according to claim 15, wherein the workpiece table comprises the sensor device and the sensor device comprises a first workpiece sensor and a second workpiece sensor, wherein the first workpiece sensor and the second workpiece sensor are spaced apart from one another in the direction of the saw line.

20. The woodworking machine according to claim 19, wherein the sensor device comprises a third workpiece sensor, wherein the third workpiece sensor is arranged offset in a horizontal direction and transversely to the saw line with respect to the first workpiece sensor and the second workpiece sensor, and wherein the third workpiece sensor is arranged between the first workpiece sensor and the second workpiece sensor in the direction of the saw line.

21. The woodworking machine according to claim 20, wherein at least two of the workpiece sensors of the sensor device are arranged on a sensor carrier, wherein the workpiece table comprises the sensor carrier.

22. The woodworking machine according to claim 21, wherein the sensor carrier is recessed into the workpiece table.

23. The woodworking machine according claim 19, wherein at least one workpiece sensor of the sensor device is arranged in the direction of the saw line in front of the saw slot.

24. The woodworking machine according to claim 15, wherein the control unit is adapted to receive a guide signal characterizing a guiding cutting at the parallel stop or at the angle stop; and
wherein the control unit is further adapted to generate an actuator control signal upon receipt of a guide signal characterizing a leading cutting at the angle stop, wherein the actuator moves the parallel stop away from the saw line upon receipt of the actuator control signal.

25. The woodworking machine according to claim 15, wherein the workpiece table further comprises a stop actuation sensor, wherein:
the stop actuation sensor is arranged in the direction of the saw line behind the saw slot and adapted to generate a first stop actuation signal, wherein the first stop actuation signal characterizes a non-presence of a workpiece in the area adjacent to the stop actuation sensor, and wherein the control unit, upon receipt of the first stop actuation signal, generates a second actuator control signal that controls the actuator such that the workpiece stop is moved to move the workpiece stop surface toward the saw line; and
the stop actuation sensor is adapted to generate a second stop actuation signal, wherein the second stop actuation signal characterizes a presence of a workpiece in the area adjacent to the stop actuation sensor, and wherein the control unit, upon receipt of said second stop actuation signal, generates a third actuator control signal that prevents a movement of the workpiece stop surface toward the saw line.

26. The woodworking machine according to claim 15, wherein the control unit is adapted to generate a lowering signal when the sensor signal is received, wherein the lowering signal controls an actuator configured as a lowering actuator such that the circular saw blade is moved below the workpiece support surface.

27. The woodworking machine according to claim 15, wherein the control unit is adapted to generate a saw blade switch-off signal when the sensor signal is received, and wherein the saw blade switch-off signal controls a drive motor of the saw blade such that the drive of the circular saw blade is switched off.

28. The woodworking machine according to claim 25, wherein:
at least one workpiece sensor or the stop actuation sensor is selected from the group consisting of:
optical sensors;
capacitive sensors;
inductive sensors;
pneumatic sensors;
linear longitudinal sensors; and
ultrasonic sensors.

29. The woodworking machine according to claim 15, wherein the woodworking machine has a first workpiece stop and a second workpiece stop, wherein the first workpiece stop is configured as a parallel stop, and the second workpiece stop is configured as a stop flap on an angle stop.

30. The woodworking machine according to claim 29, wherein the parallel stop comprises a right-hand stop.

31. A method for controlling a woodworking machine comprising the steps of:
cutting a plate-shaped workpiece with a circular saw blade that defines a saw line, wherein one side of the workpiece is arranged at a workpiece stop surface of a movable workpiece stop, by means of a cut having a start of cut and an end of cut;
detecting of the end of cut or the start of cut; and
moving the workpiece stop such that, depending on the detection of the end of cut, a clamping distance leading to clamping of the workpiece between the circular saw blade and the workpiece stop surface is suspended, by:
moving the workpiece stop surface horizontally;
pivoting the saw blade about a horizontal axis;
moving the saw blade vertically; or
stopping the saw blade.
